(19) United States
(12) Patent Application Publication
(10) Pub. No.: US 2003/0019116 A1
(43) Pub. Date: Jan. 30, 2003

(54) Drywaller tape measure

(76) Inventor: Harlen E. DeWall, Escondido, CA (US)

Correspondence Address: Mr. Loyal M. Hanson, Hanson Law Corporation, P.O. Box 430, Fallbrook, CA, 92088-0430, US

(21) Appl. No.: 09/917,987

(22) Filed: Jul. 30, 2001

(51) Int. Cl. B43L 13/02; B43L 9/04; G01B 3/10

(52) U.S. Cl. 33/42; 33/27.032; 33/770

(57) ABSTRACT

A tape measure, also called a “tape rule” and a “coilable rule,” includes a coilable rule housing and a retractable measuring blade with a free end that extends out of the housing. A finger-protecting component connected to the housing provides a bearing surface beneath the measuring blade for a person to place against and slide along an edge of a sheet of drywall as the person uses the tape measure in combination with a utility knife or other cutting tool to make a longitudinally extending cut in the sheet of drywall parallel to the edge of the sheet of drywall. The finger-protecting component preferably includes a nail-receiving hole enabling the user to rotatably fix the tape measure at the center of a desired arc with a nail in order to use the tape measure in conjunction with the utility knife for purposes of cutting an arc of a desired radius in a sheet of drywall. The measuring blade of one embodiment includes numerals arranged to be viewed right side up when holding the housing in the left hand with the measuring blade extending from the housing toward the right, together with one-eighth-inch graduations and blue-colored off-measurement numerals between the twelve-foot and the eight-foot marks.

### BACKGROUND OF THE INVENTION

1. Technical Field

This invention relates generally to building construction tools and equipment, and more particularly to a tape measure that is particularly suited to the needs of drywall installers.

2. Description of Related Art

The term “drywall” refers to the gypsum wallboard that is used to cover the wall studs or other framework of a building. The term “drywaller” refers to a person that installs the drywall. A tape measure is an important tool of the drywaller's trade and existing tape measures have some drawbacks that need to be over come.

Consider a typical tape measure constructed according to the prior art as it is used by a right-handed drywaller to mark a measurement on a sheet of drywall. The tape measure (also referred to sometimes as a “tape rule” and as a “coilable rule”) includes a handheld housing (referred to as a “coilable rule housing”) and a spring-powered, retractable metal tape or measuring blade within the housing. The measuring blade may typically measure fifteen to twenty-five feet long and it includes a free end extending out of an opening in the housing and a hook member on the free end (i.e., a “tape hook”). The drywaller holds the coilable rule housing in his left hand, withdraws a length of the measuring blade from the housing, engages the edge of a sheet of drywall with the tape hook, marks a desired measurement on the sheet of drywall with a pencil or other marker held in his right hand by referring to numerals and graduations on the measuring blade, and then releases the measuring blade so that it can return back into the housing under influence of a spring-powered coiling apparatus within the housing.

Sometimes the drywaller marks a standard twelve-foot long sheet of drywall by referring to the amount to be cut off instead of the amount that is to remain. The amount to be cut off may typically be anywhere from less than an inch to four feet or so, and drywallers refer to this as the “off-measurement.” Holding the coilable rule housing in his left hand with the measuring blade lying lengthwise on the sheet of drywall and the tape hook engaging the far end of the sheet, the drywaller measures back from the twelve-foot mark the sheet the amount of the off-measurement. He does this as best he can with reference to the conventional numerals on the measuring blade between the twelve-foot and eight-foot marks, marking the sheet with a pencil or other marker held in his right hand.

To make a longitudinally extending cut in a sheet of drywall at a desired distance from the edge of the sheet, the drywaller holds the coilable rule housing in his left hand and a utility knife in his right hand. Next, he withdraws a length of the measuring blade and engages the blade of the utility knife with the tape hook. Then, he makes the longitudinally extending cut in the sheet of drywall with the utility knife while sliding the index finger of his left hand along the edge of the sheet of drywall as a guide. Doing so, maintains the blade of the utility knife at a desired distance from the edge of the sheet of drywall. To cut an arc of desired radius in a sheet of drywall, the drywaller must often resort to some other tool to draw the arc. After drawing the desired arc on the sheet of drywall, he cuts the sheet with his utility knife.

Several problems arise in performing the above-described operations with some existing tape measures. First, graduations on the measuring blade of existing tape measures are often spaced apart by one-sixteenth of an inch or less. They are intended for use in making measurements down to within a tolerance of one-sixteenth of an inch or less, not for the relatively rough one-eighth of an inch or greater tolerance of the measurements used by drywallers. The task of quickly and correctly marking sheets of drywall is only complicated by graduations spaced apart by less than one-eighth of an inch. In addition, existing tape measures have numerals arranged for use with the coilable rule housing held in the right hand and the measuring blade extending toward the left. When the coilable rule housing is held in the left hand with the blade extending toward the right, as typically done by a right-handed drywaller, the numerals are upside down to the drywaller and that further complicates the task of quickly and correctly marking measurements. The off-measurement technique has problems too. The drywaller must disregard the conventional numerals on the measuring blade and attempt to choose the correct graduation for the off-measurement to be made. That even further complicates the measurement operation. Thus, drywallers need a tape measure with graduations and numbers that better suit the way they use the tape measure.

Next consider the cutting operation in which the drywaller makes a longitudinally extending cut in a sheet of drywall with the utility knife while sliding the index finger of his left hand along the edge of the sheet of drywall as a guide. Sliding the index finger that way too frequently can

be damaging, resulting in blisters and even a bleeding index finger. A better way is needed. As for the arc-cutting operation, it would be advantageous if the drywaller could use the tape measure for that purpose also. Thus, drywallers need a tape measure designed to facilitate these operations also.

### SUMMARY OF THE INVENTION

This invention addresses the concerns outlined above by providing a tape measure having features especially suited for drywallers. The tape measure includes a finger guard on the housing for use in making longitudinally extending cuts. The finger guard includes a nail-receiving hole so that it can be rotatably fixed with a nail at a desired center point in order to enable use of the tape measure for cutting an arc of a desired radius. The measuring blade of the tape measure includes one-eighth-inch graduations, numerals that appear right side up to a right-handed drywaller, and distinctive off-measurement numerals between at least the twelve-foot mark and the eight-foot mark.

To paraphrase some of the more precise language appearing in the claims, a tape measure constructed according to the invention includes a coilable rule housing and a retractable measuring blade extending out of the housing. The housing may be similar in many respects to existing coilable rule housings. It defines an opening through which a free end of the measuring blade extends to a tape hook on the free end.

According to one aspect of the invention, a finger-protecting component is provided connected to the coilable rule housing as means for providing a bearing surface beneath the measuring blade that a user can place against and slide along an edge of a sheet of drywall as the user makes a longitudinally extending cut in the sheet of drywall extending parallel to the edge of the sheet of drywall with a utility knife hooked by the tape hook. The finger-protecting component preferably includes a nail-receiving hole enabling the user to rotatably fix the tape measure at the center of a desired arc in order to use the tape measure in conjunction with the utility knife for purposes of cutting an arc of a desired radius in a sheet of drywall. The measuring blade of one embodiment includes numerals arranged to be viewed right side up when holding the housing in the left hand with the measuring blade extending from the housing toward the right, together with one-eighth-inch graduations and blue-colored off-measurement numerals between the twelve-foot mark and the eight-foot mark.

Thus, the tape measure of this invention significantly facilitates various operations routinely performed by a drywaller. It protects his index finger. It enables radius cuts. It provides graduations and numerals on the tape blade that are better suited to the needs of a drywaller. The following illustrative drawings and detailed description make the foregoing and other objects, features, and advantages of the invention more apparent.

### BRIEF DESCRIPTION OF THE DRAWINGS

FIG. 1 of the drawings is an isometric view of an existing tape measure constructed according to the prior art, shown in use by a person in combination with a utility knife to make a longitudinally extending cut in a sheet of drywall;

FIG. 2 is an isometric view similar to FIG. 1 of a drywaller tape measure constructed according to the instant invention, with a portion of the measuring blade broken away for illustrative convenience;

FIG. 3 is an isometric view showing the underside and finger guard aspects of the drywaller tape measure;

FIG. 4 is an isometric view showing the drywaller tape measure being used to cut an arc of a desired radius in a sheet of drywall;

FIGS. 5-9 are plan views of various segments of the measuring blade of the drywaller tape measure, showing aspects of the numerals and graduations on the measuring blade;

FIG. 10 shows a removably attachable finger-protecting assembly constructed according to the invention for use with a prior art tape measure; and

FIG. 11 is a side elevation view of a removably attachable finger-protecting device.

### DESCRIPTION OF THE PREFERRED EMBODIMENTS

FIG. 1 of the drawings shows a prior art tape measure 10 being used by a right-handed person, drywaller 11, to make a longitudinally extending cut 12 in a sheet 13 of drywall (e.g., a 12-foot long by 4-foot wide sheet of ⅝″ thick drywall). The tape measure 10 includes a coilable rule housing 14 and a measuring blade 15 with an upperside 15A, an underside 15B, a free end 16, and a tape hook 17 on the free end 16. The drywaller 11 grasps the housing 14 in his left hand 11A and a utility knife 18 (i.e., a cutting tool) in his right hand 11B. He hooks the tape hook 17 onto a blade 18A of the utility knife 18 and withdraws a sufficient amount of the measuring blade 15 from the housing 14 to align a desired graduation on the upperside 15A of the measuring blade 15 (e.g., a graduation for 6-½ inches) with an edge 19 of the sheet 13. He places his index finger 11C of his left hand 11A on the edge 19 as illustrated, beneath an underside 15B of the measuring blade 15, and slides his index finger 11C along the edge 19 as he makes the cut 12, as depicted by an arrow A in FIG. 1. After doing that often enough, his index finger blisters, bleeds, and aches. Notice also that the measuring blade numerals on an upperside 15A of the measuring blade 15 are upside down from the viewpoint of the drywaller 11, only the upside down numerals “2” through “7” being visible in FIG. 1.

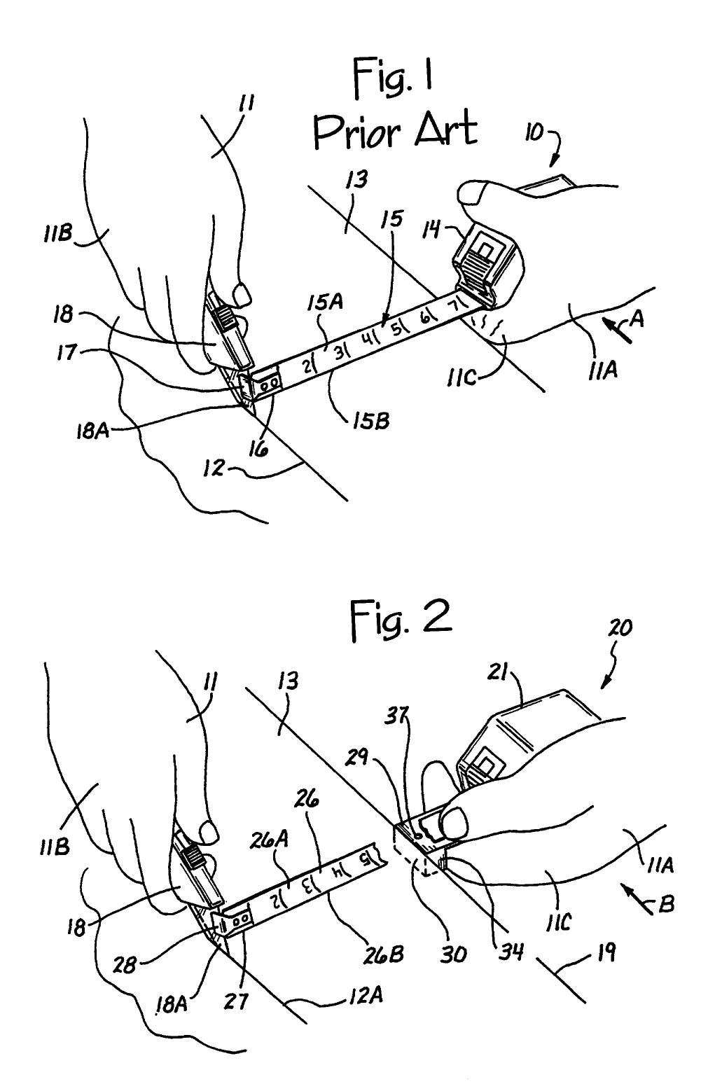

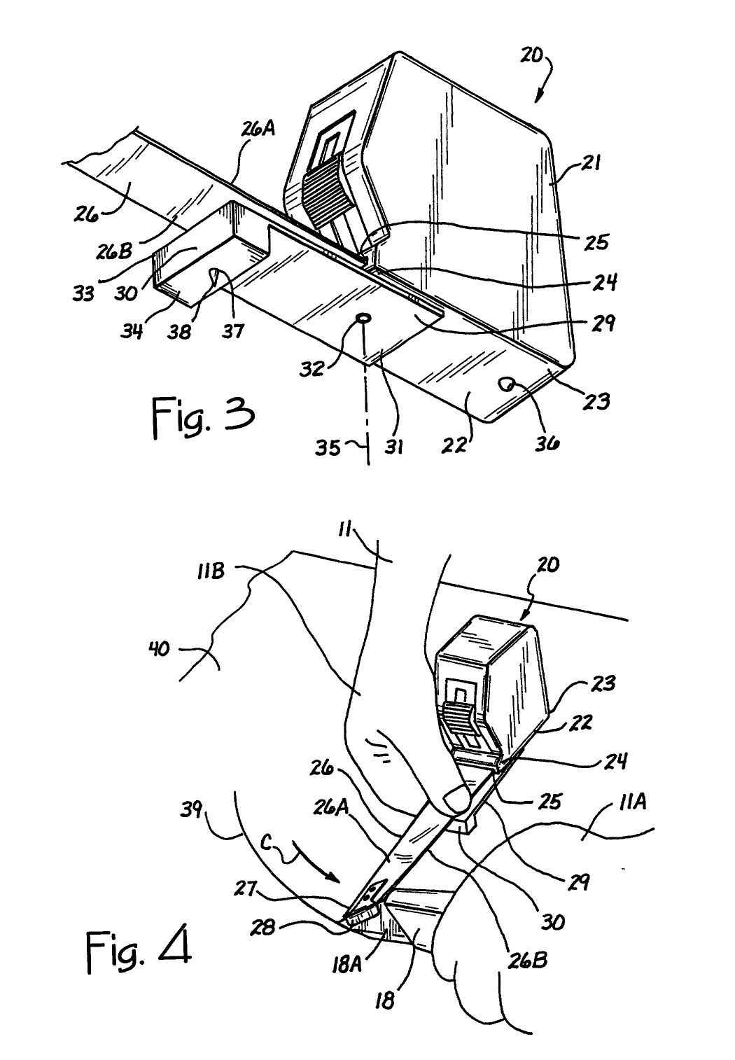

Now consider FIGS. 2-9 of the drawings. They show various aspects of a tape measure 20 that is constructed according to the invention with features especially suited to the needs of the drywaller 11. Generally, the tape measure 20 (a drywaller tape measure) includes a coilable rule housing 21 (FIGS. 2-4) having a base 22 (FIGS. 3 and 4) that extends from a rearward end 23 of the base 22 to a forward end 24 of the base 22. The housing 21 defines an opening 25 in the housing 21 at the forward end 24 of the base 22 (FIGS. 3 and 4), and the tape measure 20 includes a retractable measuring blade 26 within the housing 21 that has an upperside 26A, an underside 26B, and a free end 27 extending out of the housing 21 through the opening 25 to a tape hook 28 on the free end 27.

The foregoing features of the tape measure 20 may be similar in many respects to existing tape measures, including the tape measures sold under the trademark STANLEY by The Stanley Works of New Britain, Conn. Typical details of construction are readily available, including details described in U.S. Pat. Nos. 4,153,996; 4,434,952; 4,972,601; 4,930,227; and others. The base 22 may measure about three inches long, for example, with the rest of the chrome-plated coilable rule housing 21 being dimensioned accordingly to hold a 25-foot long, one-inch wide, mylar-coated metal measuring blade 26. Of course, those measurements and embellishing details may vary significantly without departing from the invention.

Unlike the tape measure 10 and other existing tape measures, the tape measure 20 includes a finger-protecting component 29 (FIGS. 2-4) connected to the base 22 of the housing 21. The finger-protecting component 29 is adapted to function as means for providing a bearing surface 30 (FIGS. 2-4) beneath the measuring blade 15 that the drywaller 11 can place against and slide along the edge 19 of the sheet 13 of drywall (as depicted by an arrow B in FIG. 2) as the drywaller 11 uses the tape measure 10 in combination with the utility knife 18 to make a cut 12A extending parallel to the edge 19 of the sheet 13 of drywall. The bearing surface is beneath the measuring blade 15 in the sense that it is disposed beneath the underside 15B of the measuring blade 15 when the measuring blade 15 is extending out of the housing 21 in a normal operative position of the measuring blade 15 in which it extends horizontally from the housing 21, with the upperside 15A facing upwardly so that measuring blade numerals on the measuring blade 15 face upwardly toward the drywaller 11 (e.g., the position shown in FIG. 2).

In other words, the finger-protecting component 29 is connected to the housing 21 as means for providing a bearing surface disposed beneath the measuring blade 15 (e.g., the bearing surface 30). The bearing surface is for the drywaller 11 or other user to place against and slide along an edge of a sheet of drywall (e.g., the edge 19 of the sheet 13 of drywall) as the drywaller 11 uses the tape measure 10 in combination with the utility knife 18 or other cutting tool to make a longitudinally extending cut in the sheet 13 of drywall so that the cut is parallel to and spaced apart a desired distance from the edge 19 (e.g., the cut 12A in FIG. 2). The drywaller 11 aligns a desired measurement on the measuring tape with the bearing surface 30 and then makes the cut 12A with his index finger 11C disposed rearwardly of the bearing surface 30 and away from the edge 19 of the sheet 13 of drywall. Doing so avoids damage to his index finger 11C.

The illustrated finger-protecting component 29 is an elongated member (e.g., a 3-inch long strip of ⅛-inch thick metal stock or other rigid material). It has a first end portion 31 (FIG. 3) connected pivotally to the base 22 of the housing 21 by suitable means (e.g. a screw 32 identified in FIG. 3) and a second end portion 33 opposite the first end portion 31 that includes a downwardly extending portion 34 that provides the downwardly extending bearing surface 30. The finger-protecting component 29 is shown in FIGS. 2-4 in a deployed position in which the second end portion 33 extends beyond the forward end 24 of the base 22 in the direction the measuring blade 26 extends. To move the finger-protecting component 29 to a storage position in which the second end portion 33 does not extend beyond the forward end 24, the drywaller 11 pivots the finger-protecting component 29 180 degrees about an axis 35 (FIG. 3) that is perpendicular to the base 22 until a spring-loaded ball 36 in FIG. 3 (or other suitable downwardly protruding member) seats in a hole 37 in the second end portion 33 of the finger-protecting component 29. To pivot the finger-protecting component 29 180 degrees back to the deployed position, the drywaller 11 applies a little extra pivotal pressure to the finger-protecting component 29 and that dislodges it from the spring-loaded ball 36.

The hole 37 is identified in FIGS. 2 and 3. It is a through bore that can receive a nail 38, as shown in FIG. 3, for use in cutting an arc-shaped cut 39 in a sheet 40 of drywall as shown in FIG. 4. The drywaller 11 presses the nail 38 into the sheet 40, aligns a desired measurement on the measuring blade 26 with the nail 38, hooks the tape hook 28 onto the blade 18A of the utility knife 18, and then moves the utility knife 18 in an arc, as depicted by an arrow C in FIG. 4, to form the arc-shaped cut 39.

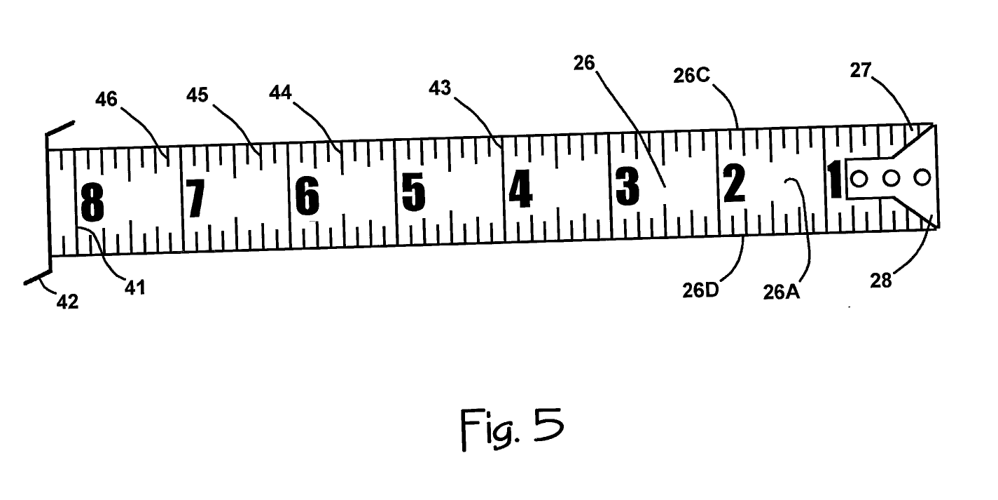

Further features of the drywaller tape measure 20 are shown in FIGS. 5-9 with reference to various segments of the measuring blade 29. FIG. 5 shows a segment extending from the free end 27 of the measuring blade 29 to one-quarter inch past an one-eighth-inch mark 41, a bold line 42 that simply indicates the end of the section shown in FIG. 5. Inch marks, including the eight-inch mark 41 and a four-inch mark 43, extend fully across the measuring blade 26 adjacent a numeral indicating which inch-mark it is, extending from an upper edge 26C to a lower edge 26D. The one-eighth-inch mark 41 is adjacent the numeral “8” and the four-inch mark 43 is adjacent the numeral “4,” for example. Like a one-half-inch mark 44, a one-quarter-inch mark 45, and a one-eighth-inch mark 46, the inch marks are graduations that are painted, printed, or otherwise placed upon the measuring blade 26. The numerals and graduations in FIG. 5 are colored black, for example, upon a yellow upperside 26A of the measuring blade 26.

According to one aspect of the invention, the numerals are arranged so that they appear right side up as shown in FIG. 5 when the free end 27 of the measuring blade 26 is disposed to the right. The numerals appear right side up to a person when the measuring blade 26 is extending from left to right ahead of the person, with the upperside 26A of the measuring blade 26 facing upwardly toward the person and the free end 27 to the right of the rest of the measuring blade 26. State another way, the measuring blade 26 includes numerals that are arranged on the measuring blade 26 to be viewed right side up by a person holding the housing 21 in the left hand of the person with the measuring blade 26 extending in front of the person toward a right side of the person. According to another aspect of the invention, the graduations are at intervals of no less than one-eighth of an inch. In other words, there are no one-sixteenth of an inch graduations, no one-thirty-second of an inch graduations, and no other graduations at intervals measuring less than one-eighth of an inch.

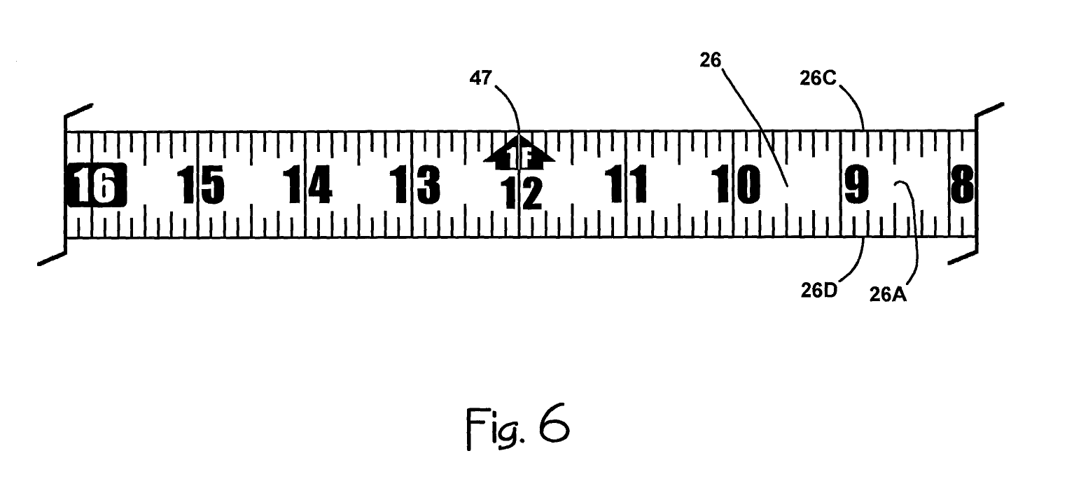

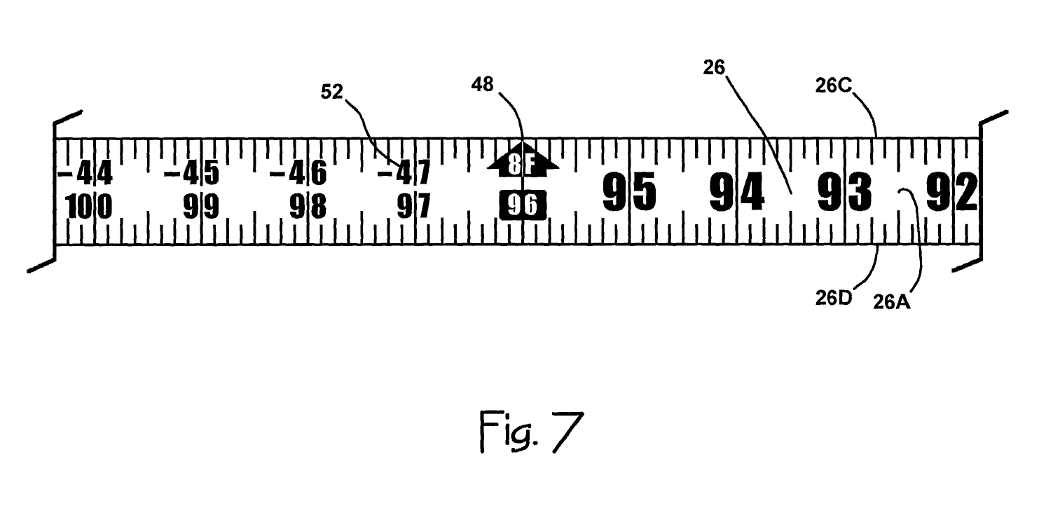

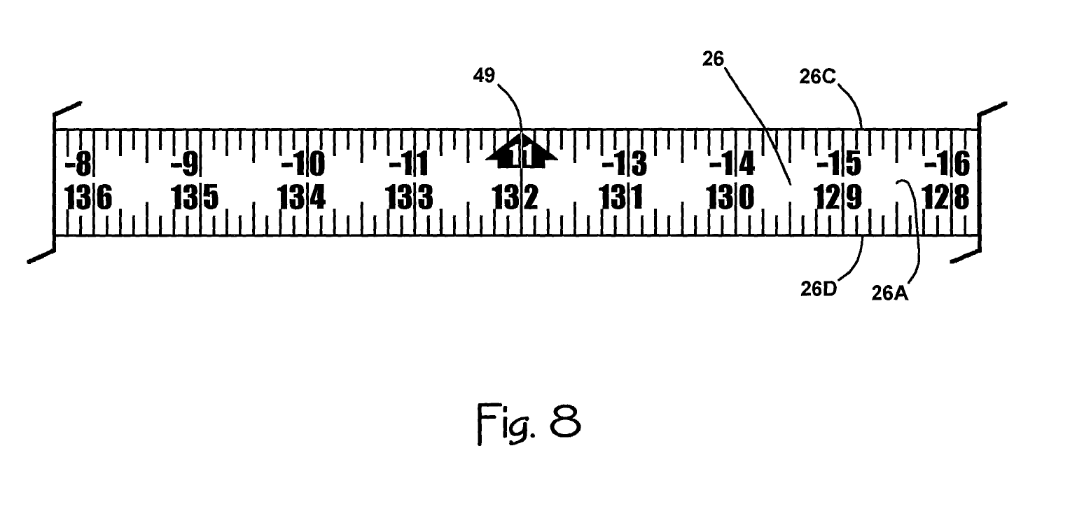

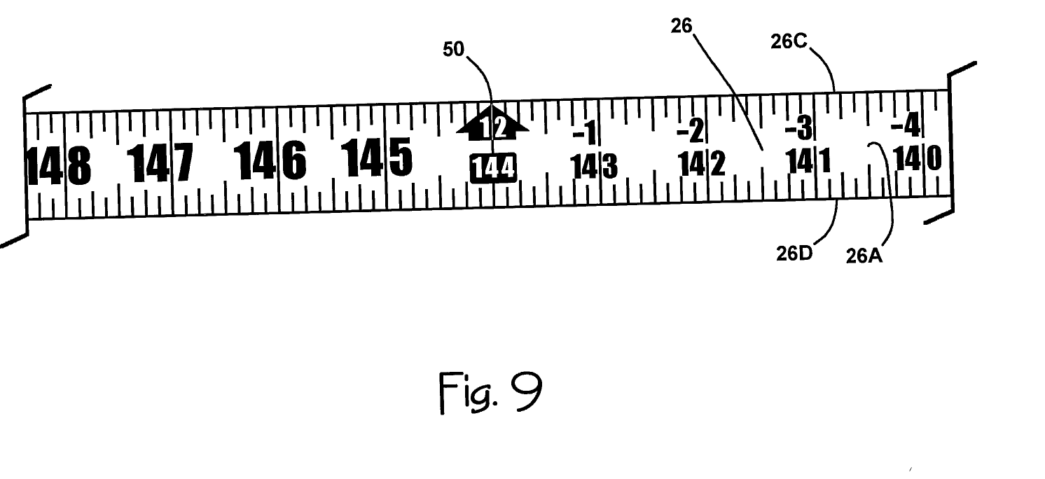

FIG. 6 shows another segment of the measuring blade 26. The same coloring scheme prevails. A one-foot mark 47 is identified. FIG. 7 shows a segment of the measuring blade 26 in the vicinity of an eight-foot mark 48. FIG. 8 shows a segment in the vicinity of an eleven-foot mark 49, and FIG. 9 shows a segment in the vicinity of a twelve-foot mark 50. As shown in FIGS. 7-9, the measuring blade 26 includes off-measurement numerals between the twelve-foot mark 50 and the eight-foot mark 48, beginning with an off-measurement numeral “−1” near the twelve-foot mark 50 (identified in FIG. 9 by a reference numeral 51), all the way to an off-measurement numeral “−47” near the eight-foot mark 48 (identified in FIG. 7 by a reference numeral 52). The off-measurement numerals indicate the distance from the 12-foot mark 50, and they appear along the upper edge 26C of the measuring blade 26. Each off-measurement numeral includes a minus sign and each is colored blue, although another color may be used (e.g., orange). The usual numerals between the eight-foot mark and the twelve-foot mark (“97” up to “143”) appear along the lower edge 26D. The drywaller 11 uses the off-measurements as previously described, to measure the amount to be cut off the 12-foot long sheet of drywall.

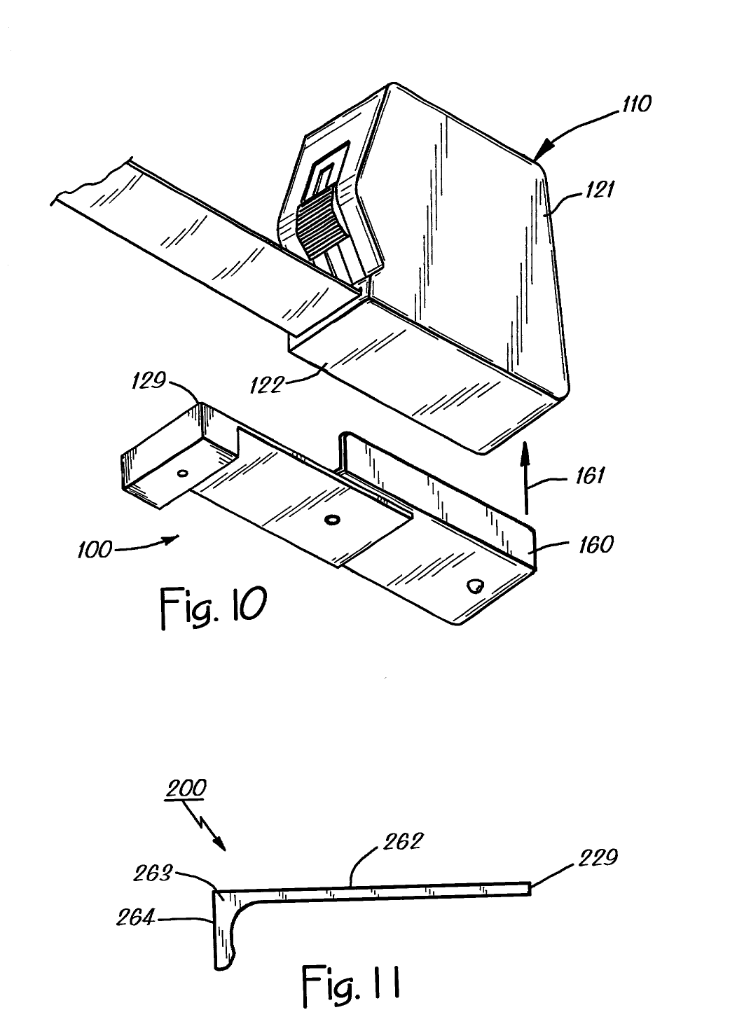

Turning now to FIG. 10, it shows a finger-protecting assembly 100 in a position to be mounted on a base 122 of a prior art tape measure 110 having a coilable rule housing 121 with a base 122. The finger-protecting assembly 100 includes a finger-protecting component 129 and a secondary base component 160. The finger-protecting component 129 is similar to the finger-protecting component 29 described above, except that it is not connected directly to the base 122 of the tape measure 110. It is connected pivotally to the secondary base component 160, and the secondary base component is suitably shaped and dimensioned to be removably attached to the base 122. With the secondary base component 160 attached to the base 122, the finger-protecting component 129 operates and functions similar to the finger-protecting component 129.

The illustrated secondary base component 160 is composed of a suitably rigid material that resiliently deforms and recovers and thereby clips onto the base 122 as it is moved upwardly and onto the base 122 as depicted by an arrow 161 in FIG. 10. Other attachment means may be used, including mating hook-and-loop fasteners of the type sold under the trademark VELCRO that are attached to the base 122 and the secondary base component 160. FIG. 11 shows a finger-protecting component 200 in the form of an elongated component 229 (similar to the finger-protecting component 29) that has an upper surface 262 for attachment directly to the base 122 with mating hook-and-loop fasteners (not shown). The elongated component 229 includes a distal end portion 263 that provides a downwardly extending bearing surface 264. Unlike the finger-protecting components 29 and 129, the finger-protecting component 200 does not pivot.

Thus, the invention provides a drywaller tape measure having features particularly suited to the needs of a drywaller that significantly facilitates various operations routinely performed by a drywaller. It protects his index finger. It enables radius cuts. It provides one-eighth-inch graduations and off-measurement numerals on the tape blade that are better suited to the needs of a drywaller. Although an exemplary embodiment has been shown and described, one of ordinary skill in the art may make many changes, modifications, and substitutions without necessarily departing from the spirit and scope of the invention.

What is claimed is:

1. A tape measure, comprising:
a coilable rule housing;
a retractable measuring blade having a free end extending out of the coilable rule housing; and
a finger-protecting component connected to the coilable rule housing as means for providing a bearing surface disposed beneath the measuring blade for a user to place against and slide along an edge of a sheet of drywall as the user uses the tape measure in combination with a cutting tool to make a longitudinally extending cut in the sheet of drywall parallel to the edge of the sheet of drywall.

2. A tape measure, comprising:
a coilable rule housing having a base extending from a rearward end of the base to a forward end of the base, the housing defining an opening in the housing at the forward end of the base;
a retractable measuring blade within the coilable rule housing, the retractable measuring blade having a free end extending out of the coilable rule housing through the opening; and
a finger-protecting component connected to the base of the coilable rule housing, which finger-protecting component is adapted to function as means for providing a bearing surface beneath the measuring blade for a person to place against and slide along an edge of a sheet of drywall as the person uses the tape measure in combination with a cutting tool to make a longitudinally extending cut in the drywall parallel to the edge of the sheet of drywall.

3. A tape measure as recited in claim 2, wherein the finger-protecting component is connected to the base movably for movement between a deployed position in which the finger-protecting component extends beyond the forward end of the base and a storage position in which the finger-protecting component does not extend beyond the forward end of the base.

4. A tape measure as recited in claim 2, wherein the finger-protecting component is connected to the base pivotally for movement between a deployed position in which the finger-protecting component extends beyond the forward end of the base and a storage position in which the finger-protecting component does not extend beyond the forward end of the base.

5. A tape measure as recited in claim 2, wherein the finger-protecting component includes an elongated member having a first end portion connected pivotally to the base of the coilable rule housing, a second end portion opposite the first end portion, and a downwardly extending bearing surface on the second end portion.

6. A tape measure as recited in claim 2, wherein the finger-protecting component includes an elongated member having a first end portion connected pivotally to the base of the coilable rule housing and a second end portion opposite the first end portion that defines a nail-receiving hole such that a person can rotatably fix the housing to a sheet of drywall at a desired center point for purposes of using the tape measure with a utility to cut an arc in the sheet of drywall.

7. A tape measure as recited in claim 2, wherein:
the finger-protecting component includes an elongated member having a first end portion connected to the base of the coilable rule housing, a second end portion opposite the first end portion, and a downwardly extending bearing surface on the second end portion;
the first end portion of the elongated member is connected to the base pivotally for movement between a deployed position in which the second end portion of the elongated member extends beyond the forward end of the base and a storage position in which the second end portion of the elongated member does not extend beyond the forward end of the base;
the second end portion of the elongated member defines a hole such that a user can insert a nail through the hole and into a sheet of drywall for purposes of using the tape measure with a utility to cut an arc in the sheet of drywall; and
the coilable rule housing includes a downwardly protruding member adapted to seat in the hole in the second end portion of the elongated member when the elongated member is in the storage position in order to thereby secure the elongated member in the storage position.

8. A tape measure as recited in claim 2, wherein the measuring blade includes numerals that are arranged on the measuring blade to be viewed right side up by a person holding the coilable rule housing in the left hand of the person with the measuring blade extending in front of the person toward a right side of the person.

9. A tape measure as recited in claim 2, wherein the measuring blade includes graduations such that none of the graduations are less than one-eighth-inch graduations.

10. A tape measure as recited in claim 2, wherein the measuring blade includes a twelve-foot mark, an eight-foot mark, and a series of off-measurement numerals indicating the off-measurement amount between the twelve-foot mark and the eight-foot mark in one-inch increments.

11. A tape measure as recited in claim 2, wherein the measuring blade includes a first series of conventional-measurement numerals that are a black color, a second series of conventional-measurement numerals that are a red color, and a series of off-measurement numerals that are a blue color.

12. A tape measure, comprising:
a coilable rule housing; and
a retractable measuring blade within the coilable rule housing that has a free end extending out of the coilable rule housing;
the measuring blade including numerals that are arranged on the measuring blade to be viewed right side up by a person holding the coilable rule housing in the left hand of the person with the measuring blade extending in front of the person toward a right side of the person;
the measuring blade including graduations such that none of the graduations are less than one-eighth-inch graduations; and
the measuring blade including a twelve-foot mark, an eight-foot mark, and a series of off-measurement numerals indicating the off-measurement amount between the twelve-foot mark and the eight-foot mark in one-inch increments.

13. A tape measure as recited in claim 12, wherein the measuring blade includes a first series of conventional-measurement numerals that are a black color, a second series of conventional-measurement numerals that are a red color, and a series of off-measurement numerals that are a blue color.

14. A finger-protecting assembly for a tape measure having a coilable rule housing with a base, the finger-protecting assembly comprising:
a finger-protecting component; and
a secondary base component to which the finger-protecting is connected pivotally;
the secondary base component being adapted to function as means for removably mounting the finger-protecting component on the base of the coilable rule housing;
whereby a user can removably mount the finger-protecting component on the base as means for providing a bearing surface disposed beneath the measuring blade for the user to place against and slide along an edge of a sheet of drywall as the user uses the tape measure in combination with a cutting tool to make a longitudinally extending cut in the sheet of drywall parallel to the edge of the sheet of drywall.

15. A finger-protecting assembly as recited in claim 14, wherein:
the finger-protecting component includes an elongated member having a first end portion connected to the secondary base component, a second end portion opposite the first end portion, and a downwardly extending bearing surface on the second end portion;
the first end portion of the elongated member is connected to the secondary base component pivotally for movement between a deployed position and a storage position.

16. A finger-protecting device for a tape measure having a coilable rule housing with a base, the finger-protecting device comprising:
an elongated member having a distal end portion and an upper surface for attachment to the base of the coilable rule housing with mating hook-and-loop fasteners; and
a downwardly extending bearing surface on the distal end portion of the elongated member;
whereby a user can removably mount the elongated member on the base with the mating hook-and-loop fasteners as means for providing a bearing surface disposed beneath the measuring blade for the user to place against and slide along an edge of a sheet of drywall as the user uses the tape measure in combination with a cutting tool to make a longitudinally extending cut in the sheet of drywall parallel to the edge of the sheet of drywall.
